(19) United States
(12) Patent Application Publication
(10) Pub. No.: US 2005/0125537 A1
(43) Pub. Date: Jun. 9, 2005

(54) Method, apparatus and system for resource sharing in grid computing networks

(76) Inventors: Fernando C. M. Martins, Hillsboro, OR (US); Milan Milenkovic, Portland, OR (US); Robert C. Knauerhase, Portland, OR (US)

Correspondence Address: INTEL CORPORATION, P.O. BOX 5326, SANTA CLARA, CA, 95056-5326, US

(21) Appl. No.: 10/723,727

(22) Filed: Nov. 26, 2003

(51) Int. Cl. G06F 15/173; G06F 15/167

(52) U.S. Cl. 709/226; 709/216

(57) ABSTRACT

A method, apparatus and system may utilize virtual machines in a grid computing environment. More specifically, hosts in a grid computing network may be configured to run various virtual machines. Additionally, these hosts may be configured to designate one or more of the virtual machines to processing grid applications. A resource manager may access predefined policies to monitor the grid virtual machine and manage resource allocation within the grid network, in conjunction with a virtual machine manager or a virtual machine monitor (“VMM”).

### FIELD

The present invention relates to the field of grid computing, and, more particularly to a method, apparatus and system for enforcing secure resource sharing in grid computing networks.

### BACKGROUND

Grid computing supports transparent sharing, selection, and aggregation of distributed resources, offering consistent and inexpensive access of the resources to grid users. By providing access to the aggregate computing power and virtualized resources of participating networked computers, grid computing enables the utilization of temporarily unused computational resources in various types of networks (e.g., massive corporate networks containing numerous idle resources). In a grid computing environment, the combined power of these previously untapped computational resources may be harvested by corporate applications, by other users in the same corporation, or even sold to external customers for profit. Thus, corporate information technology departments may have a strong motivation to purchase computing devices with significant resources (e.g., memory, hard disk space, etc.) even for users that do not have an explicit use for powerful machines. If grid computing is enabled in these environments, the surplus computing power may be available to those in need with significant cost savings and/or optimization of the corporation's resources.

A major barrier to fulfilling the grid computing vision is that current implementations of grid software entail a major security threat. The problem arises due to the fact that external grid applications and data must share the computing device's resources with the primary user's workloads and data. Attacks through the grid may result in catastrophic denial of service, leakage of confidential information, and/or simple inconvenience to the owner of the computing device. The converse is also true, i.e., grid users and applications must trust the owners of the computing device not to tamper with their data, computations, and confidential information.

### BRIEF DESCRIPTION OF THE DRAWINGS

The present invention is illustrated by way of example and not limitation in the figures of the accompanying drawings in which like references indicate similar elements, and in which:

FIG. 1 illustrates a conceptual overview of an embodiment of the present invention;

FIG. 2 illustrates a host according to an embodiment of the present invention;

FIG. 3 illustrates a host according to an alternate embodiment of the present invention; and

FIG. 4 is a flowchart illustrating an embodiment of the present invention.

### DETAILED DESCRIPTION

Embodiments of the present invention provide a method, apparatus and system for enforcing resource sharing in grid computing networks. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

According to an embodiment of the present invention, virtual machines may be utilized within a grid computing network to enhance security and enable the grid computing environment to function in isolation from other processes. More specifically, according to an embodiment, a computing device (hereafter a “host”) may include various virtual machines, each isolated from the other and capable of functioning independently. Virtual machines typically include multiple virtual operating environments within a single computing device, each seemingly in complete control of the resources of the device. Applications running within the respective virtual machines typically have no knowledge of the other virtual machines running on the host. A virtual machine manager or virtual machine monitor (hereafter “VMM”) may monitor and/or allocate the host's resources to each virtual machine on the host. VMMs are designed to ensure virtual machines (hereafter “VMs”) operate in complete isolation, as if they were separate physical devices. Even catastrophic crashes (e.g., an operating system reboot) in one VM does not affect the operation of the other VMs. Virtual machines and VMMs are well known to those of ordinary skill in the art and further detailed description of such is therefore omitted herein in order not to unnecessarily obscure embodiments of the present invention.

In one embodiment of the present invention, each host may be configured such that one or more of the virtual machines on the host are designated to run grid applications on the grid network. A resource module may supplement the functionality of typical VMMs, to establish and enforce predefined resource sharing policies according to an embodiment of the present invention. Although the description and figures herein describe the VMM and resource module as separate modules, the functionality of these two modules may be combined without departing from the spirit of embodiments of the present invention. Additionally, in various embodiments, the resource module may be implemented as software, hardware, firmware or any combination thereof.

Embodiments of the present invention may be implemented in various grid network environments. For example, in a corporate network, a research and development organization may desire to execute a large simulation requiring significant resources. As is typical in a grid network, this large simulation may be executed utilizing the resources from various hosts on the network. According to an embodiment of the present invention, however, this large simulation may be executed by multiple virtual machines residing on various hosts on the grid network. Thus, for example, various hosts may be configured to each dedicate one or more virtual machine(s) within their environment to execute this simulation while the remaining virtual machine(s) on the hosts may be available to the owner/user for his or her typical use. The VMM and resource module on each host may manage the resource allocation to enable the grid application to run without affecting the user's ability to securely use the host for other purposes.

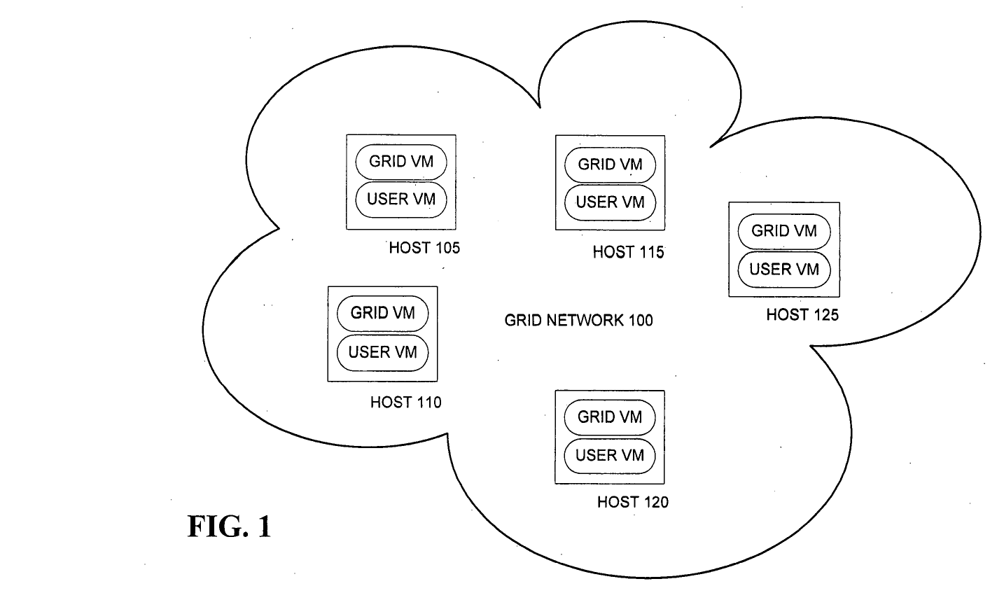

FIG. 1 illustrates a conceptual overview of an embodiment of the present invention. Hosts (illustrated as Host 105-Host 125) on the grid network (“Grid Network 100”) may designate one or more virtual machines to grid application processing (illustrated as “Grid VM” on each host), while enabling users to use other virtual machines (illustrated as “Other VM”) on their computers. By designating one or more Grid VMs for grid application processing, embodiments of the present invention provide a secure and isolated environment on various hosts within which these grid applications may be processed. Since virtual machines are isolated from each other, embodiments of the present invention address various security concerns with existing grid networks. For example, running grid applications in their own VM enables an embodiment of the present invention to manage the maximum impact of the grid applications on the local user's host machine. The local user may work within a separate virtual machine (i.e., Other VMs), with no inkling that certain resources of the computing device are periodically being allocated to process the grid application. Thus, from the user's perspective, his or her machine is not obviously being used by a third party. More importantly, because of the isolation of virtual machines within the host, the user's data and documents are protected from corruption by the grid application. Conversely, the user may not inadvertently and/or purposely tamper with the grid computing environment because the computing device may be configured such that the user does not have access to the Grid VM.

For the purposes of simplicity, only five hosts are depicted but embodiments of the present invention are not so limited. Additional hosts may be added to Grid Network 100 without departing from the spirit of embodiments of the present invention. As illustrated, these hosts are computing devices that support virtual machines. In one embodiment, these computing devices may include hardware support, e.g., computing devices with processors that support virtual machines, while in an alternate embodiment, these computing devices may include software support for virtual machines. It will be readily apparent to those of ordinary skill in the art that various computing devices may include both hardware and software support for virtual machines.

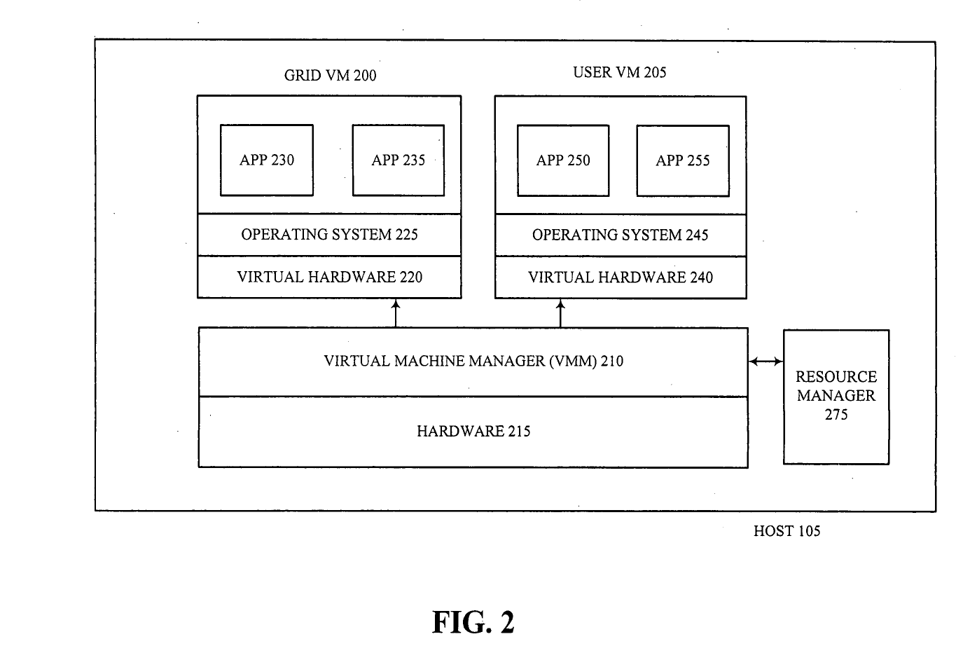

FIG. 2 illustrates a host according to an embodiment of the invention. As illustrated, Host 105 may include computer hardware with virtual machine support (“Hardware 215”), a VMM (“VMM 210”) and two virtual machines, Grid VM 200 and User VM 205. For the purposes of this example, Grid VM 200 represents the virtual machine on Host 105 that may be used by grid applications while User VM 205 represents the virtual machine which a user access to perform his or her routine tasks. Multiple other virtual machines may also be added without departing from the spirit of embodiments of the present invention. Thus, for example, in a corporate environment, User VM 205 may represent the virtual machine the user utilizes to perform work related tasks, while an additional virtual machine may be configured for the user's personal tasks (e.g., to store and play audio and video files, etc.). It will be readily apparent to those of ordinary skill in the art that the number of virtual machines on a host may be limited by the resources on the host and/or by the VMM.

Grid VM 200 and User VM 205 may each comprise a complete software stack. Thus, for example, Grid VM 200 may include drivers representing virtual hardware (“VHW 220”), an operating system (“OS 225”) and various applications (e.g., App 230 and App 235). Similarly, User VM 205 may comprise drivers representing virtual hardware (“VHW 240”), an operating system (“OS 245”) and various applications (e.g., App 250 and App 255). Grid VM 200 and User VM 205 represent separate trusted execution environments that ensure that Host 105 is protected from rogue grid applications as well as prevent local users from tampering with or snooping on the grid applications and data.

According to one embodiment, the Resource Module on Host 105 (“Resource Module 275”) may supplement the functionality of VMM 210. More specifically, VMM 210 may perform its typical management and resource allocation functions while Resource Module 275 may include supplemental resource sharing policies to enable Grid VM 200 to process grid applications without disrupting the user's access to Host 105. VMMs do not typically dynamically alter their resource allocation, i.e., regardless of the fact that one VM may be using minimal processing power, it may nonetheless be allocated an equal amount of processing time and resources as other, more active VMs. In one embodiment, Resource Module 275 may affect the resource allocation on Host 105 dynamically, as the resources on Host 105 change. In other words, Resource Module 275 may start performing its supplemental resource management functions when Grid VM 200 is started up and begins to process a grid application, and as the demands on the resources on Host 105 change, Resource Module 275 may be configured to monitor and dynamically change the resource allocation to Grid VM 200.

In one embodiment of the present invention, the resource sharing policies in Resource Module 275 may be defined by the Grid Network 100's system administrator based on a variety of factors. For example, the system administrator may configure Resource Module 275 to restrict the resources available to Grid VM 200. Thus, although VMM 210 typically allocates resources to Grid VM 200 and User VM 205 in a “round robin” fashion (e.g., for a predetermined amount of time to each virtual machine on the host) without regard for what each virtual machine is doing, Resource Module 275 may additionally include predefined policies that restrict the resources allocated to Grid VM 200 to ensure minimal disruption to the user. Examples of such predefined policy restrictions include restricting Grid VM 200 to a predetermined amount of processor use (by time and/or cycles), restricting Grid VM 200 to certain disk volumes and/or to certain files and/or blocks on Host 105, allowing Grid VM 200 access to Host 105's entire hard disk but require the total amount of storage used to be below a predetermined limit, restricting the bandwidth that Grid VM 200 may utilize, restricting the hosts on Grid Network 100 that Grid VM 200 may contact, restricting allocation of Host 105's memory to Grid VM 200 and/or prevent Grid VM 200 from using Host 105's display, and/or providing Grid VM 200 with a restricted virtual display through which the local user could monitor the status of Grid VM 200.

In yet another embodiment, Resource Module 275 may also perform dynamic load balancing across multiple hosts on Grid Network 100 by shifting grid computing workloads from one host to another, depending on each host's resource availability. Thus, for example, if a local user utilization of a given host (e.g., User VM 205 on Host 105) grows so much that it precludes timely execution of the grid workload (e.g., on Grid VM 200), Resource Module 275 may detect the condition and seek an alternative host on Grid Network 100 with available resources to execute the grid workload. Once resources are secured, the local execution of the workload may be suspended and the workload may be transferred to the new host where execution may be resumed.

It will be readily apparent to those of ordinary skill in the art that Resource Module 275 may be configured to supplement VM 210 according to a variety of other policies and factors without departing from the spirit of embodiments of the present invention.

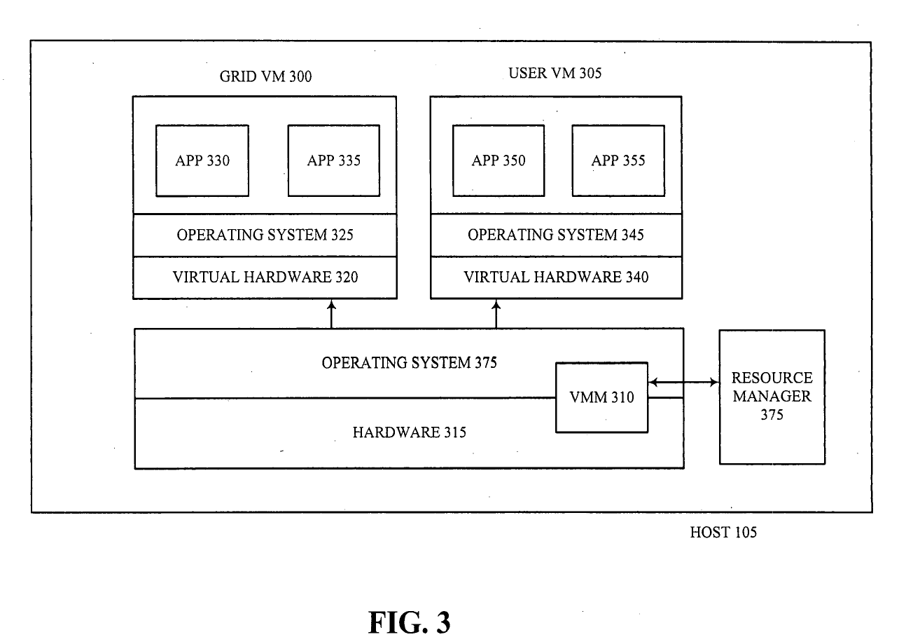

FIG. 3 illustrates a host according to an alternate embodiment of the present invention. In this embodiment, all the elements of Host 105 may be similar to the embodiment depicted in FIG. 2, with the exception of Operating System 360. In this embodiment, Operating System 360, in conjunction with Hardware 315, may provide typical support for virtual machines on Host 105. Similar to the embodiment in FIG. 2, Resource Manager 375 may be implemented to supplement the functionality of VMM 310 by providing and enforcing various resource sharing policies for Grid VM 300 and User VM 305.

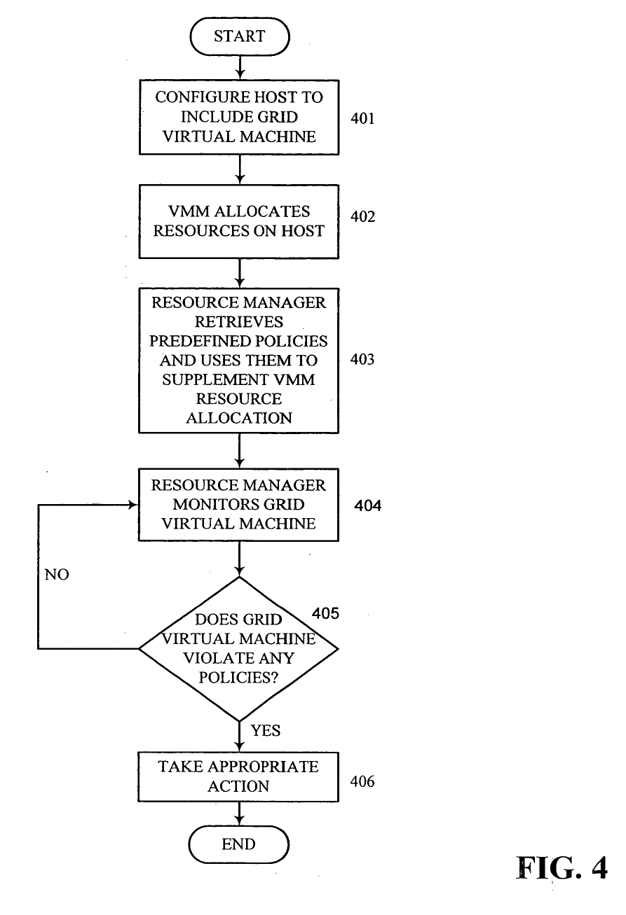

FIG. 4 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. In 401, a host is configured to include multiple virtual machines, one of which is designated a grid virtual machine capable of executing a grid application. A VMM on the host may allocate the resources of the host in 402, while in 403, a resource manager may retrieve predefined policies governing allocation of resources to the grid virtual machine and utilize these policies to supplement the VMM's resource allocation. The resource manager may monitor the allocation of resources to the grid virtual machine in 404 and examine each of the retrieved policies in 405 to determine if one or more of them have been violated. If any policy is violated, in 406, the resource manager may take appropriate action (e.g., restricting the grid virtual machine's access to resources and/or notify a system administrator and/or user). If no policies are violated, the resource manager may continue to monitor the grid virtual machine in 404 while it executes the grid application.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the computing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of sharing resources on a grid network, comprising:
configuring a host to include a grid virtual machine and a second virtual machine;
allocating resources on the host to the grid virtual machine; and
executing a grid application in the grid virtual machine.

2. The method according to claim 1 wherein allocating the resources further comprises a virtual machine manager allocating at least the portion of the resources.

3. The method according to claim 2 wherein a resource manager allocates resources to the grid virtual machine to supplement the resources allocated by the virtual machine manager.

4. The method according to claim 3 further comprising the resource manager performing dynamic load balancing on the grid network.

5. The method according to claim 1 wherein the second virtual machine is configured to run applications other than the grid application.

6. The method according to claim 1 wherein the grid virtual machine is isolated from the second virtual machine.

7. The method according to claim 1 further comprising:
retrieving predefined policies for the grid virtual machine; and
monitoring the grid virtual machine to determine if the grid virtual machine violates the predefined policies.

8. The method according to claim 7 wherein the predefined policies include predefined resource thresholds for the grid virtual machine.

9. The method according to claim 8 further comprising a resource manager taking appropriate action if the grid virtual machine violates at least one of the predefined policies.

10. The method according to claim 9 wherein the resource manager taking action further comprises at least one of the resource manager automatically limiting resources available to the grid virtual machine, and the resource manager notifying a user that the grid virtual machine violated at least one of the predefined policies.

11. An article comprising a machine-accessible medium having stored thereon instructions that, when executed by a machine, cause the machine to:
configure a grid virtual machine and a second virtual machine on a grid network;
allocate resources to the grid virtual machine; and
execute a grid application in the grid virtual machine.

12. The article according to claim 11 wherein the instructions, when executed by the machine, further cause the machine to startup a virtual machine manager, the virtual machine manager capable of allocating at least the portion of the resources to the grid virtual machine.

13. The article according to claim 12 wherein the instructions, when executed by the machine, further cause the machine to startup a resource manager, the resource manager capable of allocating resources to the grid virtual machine to supplement the resources allocated by the virtual machine manager.

14. The article according to claim 13 wherein the instructions, when executed by the machine, further cause the resource manager to perform dynamic load balancing on the virtual network.

15. The article according to claim 11 wherein the instructions, when executed by the machine, is capable of configuring the second virtual machine to run applications other than the grid application.

16. The article according to claim 111 wherein the instructions, when executed by the machine, further cause the machine to isolate the grid virtual machine from the second virtual machine.

17. The article according to claim 11 wherein the instructions, when executed by the machine, further cause the machine to:
retrieve predefined policies for the grid virtual machine; and
monitor the grid virtual machine to determine if the grid virtual machine violates the predefined policies.

18. The article according to claim 17 wherein the instructions, when executed by the machine, further cause the machine to retrieve predefined resource thresholds for the grid virtual machine.

19. The article according to claim 17 wherein the instructions, when executed by the machine, further cause the machine to startup a resource manager capable of taking appropriate action if the grid virtual machine violates at least one of the predefined policies.

20. The article according to claim 19 wherein the instructions, when executed by the machine, further cause the machine to at least one of automatically limit the resources available to the grid virtual machine, and notify a user that the grid virtual machine violated at least one of the predefined policies.

21. A system to share resources on a grid network, comprising:
a grid virtual machine on a host capable of executing a grid application;
a second virtual machine on the host coupled to the grid virtual machine;
a virtual machine manager on the host, the virtual machine manager coupled to the grid virtual machine and the second virtual machine on the host, the virtual machine manager capable of allocating the host's resources to the grid virtual machine and the second virtual machine; and
a resource manager on the host, the resource manager coupled to the virtual machine manager, the grid virtual machine and the second virtual machine, the resource manager capable of allocating resources to the grid virtual machine to supplement the resources allocated by the virtual machine manager.

22. The system according to claim 21 wherein the resource manager is additionally capable of retrieving predefined policies for the grid virtual machine and monitoring the grid virtual machine to determine if the grid virtual machine violates the predefined policies.

23. The system according to claim 22 wherein the resource manager is additionally capable of taking appropriate action if the grid virtual machine violates at least one of the predefined policies.

24. The system according to claim 23 wherein the resource manager is additionally capable of taking appropriate action by at least one of automatically limiting the resources available to the grid virtual machine, and notifying a user that the grid virtual machine violated at least one of the predefined policies.

25. A grid network, comprising:
a first host capable of running a first grid virtual machine and a second virtual machine; and
a second host coupled to the first host, the second host capable of running a second grid virtual machine and a third virtual machine, the first grid virtual machine and the second grid virtual machine capable of simultaneously executing a grid application.

26. The grid network according to claim 25 wherein the first host includes a first resource manager and the second host includes a second resource manager, the first resource manager and the second resource manager each capable of allocating resources to the first grid virtual machine and second grid virtual machine respectively.

27. The grid network according to claim 26 wherein the first resource manager and the second resource manager are additionally capable of retrieving policies for the first grid virtual machine and the second grid virtual machine respectively.

28. A method of sharing resources on a grid network, comprising:
retrieving predefined policies for a grid virtual machine on a host;
monitoring the grid virtual machine on the host to determine if the grid virtual machine violates the predefined policies; and
taking appropriate action if the grid virtual machine violates at least one of the predefined policies.

29. The method according to claim 28 wherein monitoring the grid virtual machine additionally comprises allocating resources to the grid virtual machine as necessary.

30. An article comprising a machine-accessible medium having stored thereon instructions that, when executed by a machine, cause the machine to retrieve predefined policies for a grid virtual machine on the machine;
monitor the grid virtual machine on the host to determine if the grid virtual machine violates the predefined policies; and
take appropriate action if the grid virtual machine violates at least one of the predefined policies.

31. The article according to claim 30 wherein the instructions, when executed by the machine, further cause the machine to allocate resources to the grid virtual machine as necessary.
